(19) United States
(12) Patent Application Publication
(10) Pub. No.: US 2009/0152062 A1
(43) Pub. Date: Jun. 18, 2009

(54) Position seat for a hydraulic brake device of a bicycle

(76) Inventor: Szu-fang Tsai, Changhua (TW)

Correspondence Address: SAM CHEN, 7F-1, 293, ROOSEVELT ROAD, SEC 3, TAIPEI, TW

(21) Appl. No.: 11/955,404

(22) Filed: Dec. 13, 2007

(51) Int. Cl. B60T 11/10

(52) U.S. Cl. 188/344

(57) ABSTRACT

A position seat for a hydraulic brake device of a bicycle includes a position member mounted to a handlebar of the bicycle and a pumping member partially received in the position member. The pumping member is selectively rotatable relative to the position member. A semi-annular groove is defined in an outer periphery of the pumping member and a locking pin extends through the position member and partially received in the semi-annular groove to prevent the pumping member from detaching from the position portion before being positioned and limit a rotate range of the pumping member relative to the position member.

### BACKGROUND OF THE INVENTION

1. Field of the Invention

The present invention relates to position seat, and more particularly to a position seat for a hydraulic brake device of a bicycle.

2. Description of Related Art

A hydraulic brake device of a bicycle usually includes a position seat for containing an oil trough, a main cylinder for pumping oil and a lever pivotally mounted on the position seat for operating the main cylinder.

A conventional position seat in accordance with the prior art is integrally formed by injection molding and divided into a position portion and a pumping portion. The pumping portion is provided to define an oil container and a main cylinder. In addition, a lever is pivotally mounted to the pumping portion for operating the main cylinder to pump oil to the hydraulic brake device of the bicycle. The position portion is provided to connect to the handlebar of the bicycle for holding the position seat in place.

The convention position seat is integrally formed by injection molding such that the conventional position seat has several disadvantages as follows.

1. The using scope of the conventional position seat is limited. The oil container and the main cylinder, as described above, communicate with each other by oil holes. The best cooperation mode of the oil container and the main cylinder is that the oil container is located upon the main cylinder. However, the handlebar of the bicycle is changefully designed for different types of bicycle such that it may not be ensured that the oil container is located upon the main cylinder. Consequently, the hydraulic brake device may be failed when the oil container is laterally adjacent the main cylinder and the horizontal level of the oil in the oil container is lower than that of the oil holes that communicates with the oil container and the main cylinder.

2. The bad ratio of injection molding is high. The position seat is formed to be a one-piece workpiece such that the cast has a great volume. As a result, gas holes are easily formed in the workpiece during molding. The cast with gas holes can not be provided to forming the oil container and the main cylinder.

The present invention has arisen to mitigate and/or obviate the disadvantages of the conventional position seat for a hydraulic brake device of a bicycle.

### SUMMARY OF THE INVENTION

The main objective of the present invention is to provide an improved position seat for a hydraulic brake device of a bicycle, which is adjusted relative to a type of the handlebar of the bicycle.

To achieve the objective, the position seat in accordance with the present invention comprises a position member mounted to a handlebar of the bicycle and a pumping member partially received in the position member. The pumping member is selectively rotatable relative to the position member for adjusting an assembling angle between the position member and the pumping member. A semi-annular groove is defined in an outer periphery of the pumping member and a locking pin extends through the position member and partially received in the semi-annular groove to prevent the pumping member from detaching from the position portion before being positioned and limit a rotate range of the pumping member relative to the position member.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a position seat for a hydraulic brake device of a bicycle in accordance with the present invention;

FIG. 2 is a first side plan view of a position seat for a hydraulic brake device of a bicycle in accordance with the present invention;

FIG. 3 is a cross-sectional view of the position seat in FIG. 2 along line A-A; and

FIG. 4 is a second side plan view of a position seat for a hydraulic brake device of a bicycle in accordance with the present invention.

### DETAILED DESCRIPTION OF THE INVENTION

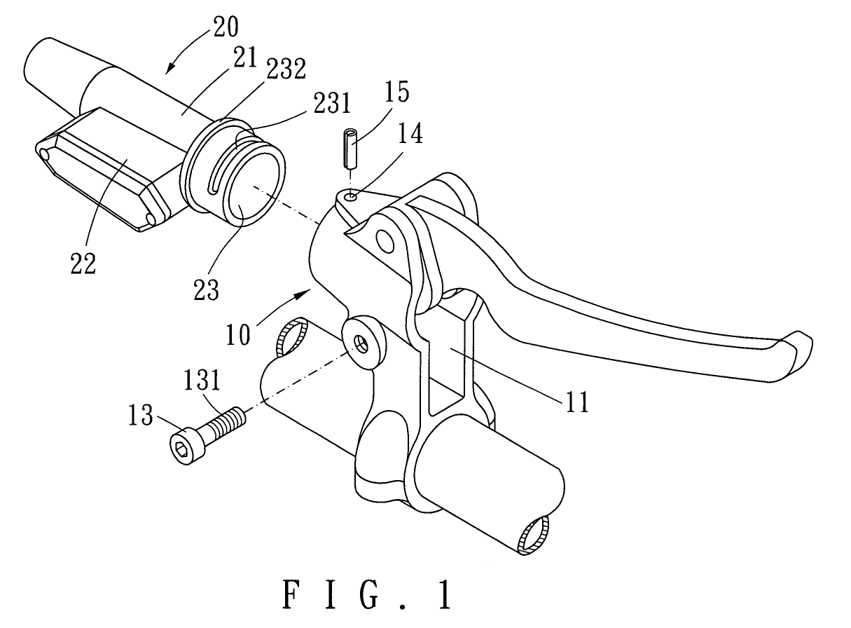

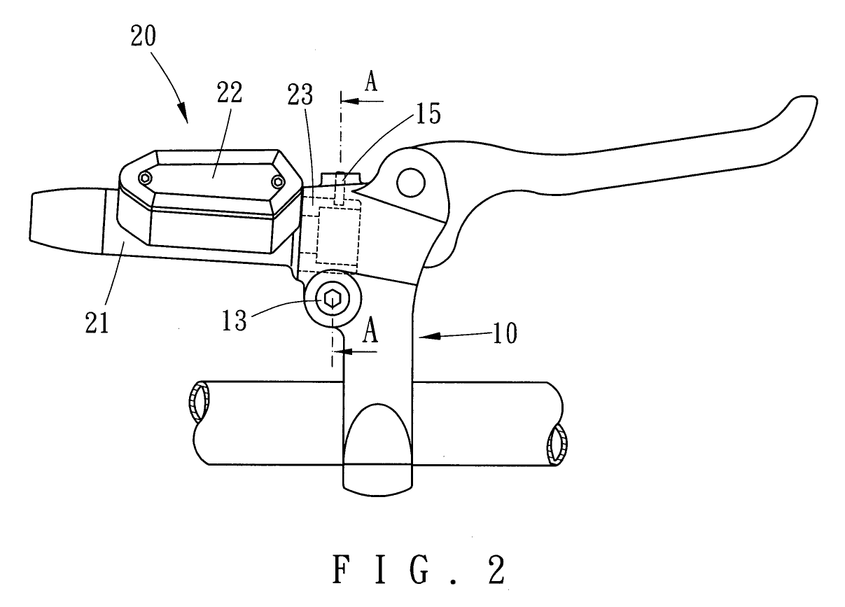

Referring to the drawings and initially to FIGS. 1 and 2, a position seat in accordance with the present invention comprises a position member (10) adapted to be mounted on a handlebar of a bicycle and a pumping member (20) selectively pivotally mounted to the position member (10). The position member (10) and the pumping member (20) are respectively formed by injection molding.

The position member (10) includes a through hole (11) and a slot (111) respectively defined in the position member (10), wherein the slot (111) is parallel to an axis of the through hole (11). The slot (111) has two opposite sides each formed with an ear (12). Each ear (12) has a threaded hole (121) defined therein. A bolt (13) sequentially extends through a threaded hole (121) and is screwed into the other to shorten the width of the slot (111) for securely forcing the pumping member (20). A hole (14) is defined in the position member (10) and communicates with the through hole (11). A locking member (15) is mounted in the hole (14) and extends into the through hole (11). In the preferred embodiment of the present invention, the locking member (15) is a spring pin.

The pumping member (20) has a hollow structure. The pumping member (20) includes a cylinder portion (21) and containing portion (22) disposed therein. The containing portion (22) is adjacent to the cylinder portion (21). The cylinder portion (21) is provided to containing a main cylinder of the hydraulic brake device and the containing portion (22) is provided to contain oil of the hydraulic brake device of a bicycle. A sheath (23) longitudinally extends from the cylinder portion (21) and is received in the through hole (11). A semi-annular groove (231) is defined in an outer periphery of the sheath (23) and communicates with the hole (14) for partially receiving the locking member (15) to prevent the pumping member (20) from detaching from the position portion (10) before screwing the bolt (13) and limit a rotate range of the pumping member (20) relative to the position member (10). An annular flange (232) outward and radially extends from the cylinder portion (21) to prevent the cylinder portion (21) from overly extending into the through hole (11) and ensure the semi-annular groove (231) communicating with the hole (14) when the sheath (23) is received in the through hole (11). In addition, the bolt (13) has a neck portion (131) defined near an enlarged head thereof. The neck portion (131) is rotatably received in a corresponding one of the two threaded holes (121) to prevent a locked condition from being occurred among the two ears (12) and the bolt (13) in place when screwing the bolt (13) before holding the sheath (12).

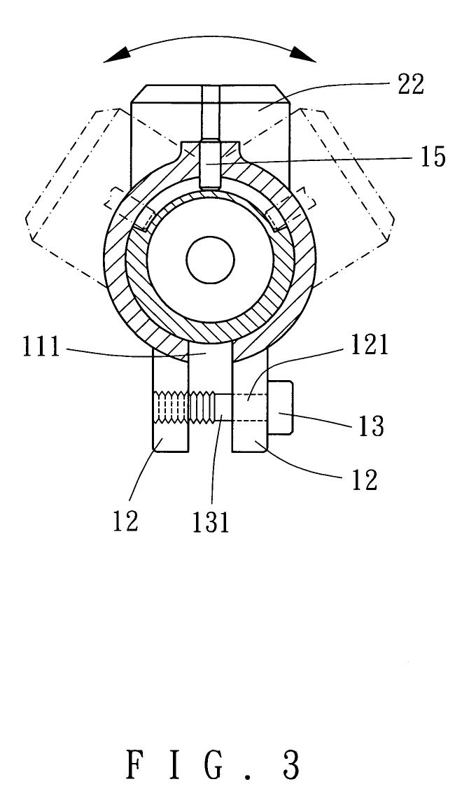

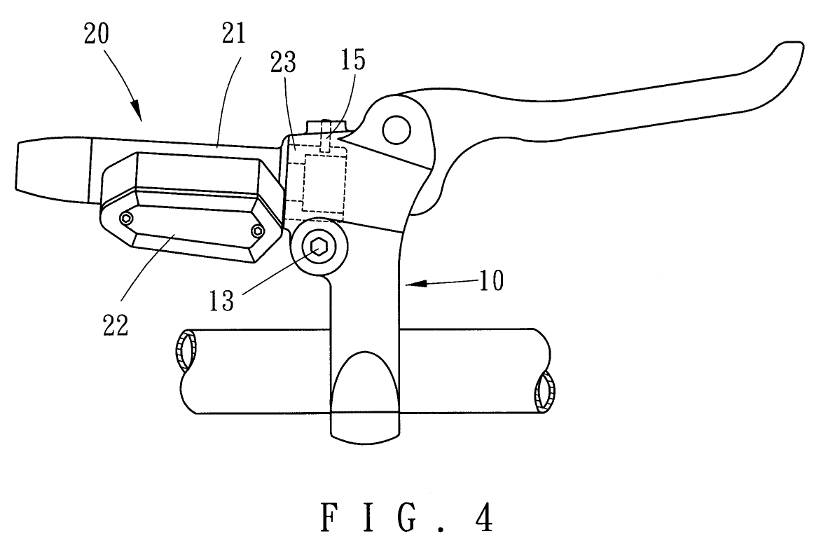

With reference to FIGS. 2-4, the inner periphery of the through hole (11) does not securely bind the sheath (23), the pumping member (20) can be rotated relative to the position member (10) for adjust an assembling angle between the position member (10) and the pumping member (20), and the locking member, partially received in the semi-annular groove (231) can prevent the pumping member (20) from detaching from the position member (10) when the bolt (13) is reversely screwed. The bolt (13) is tightly screwed to make the inner periphery of the through hole (11) securely bind the sheath (23) again when the assembling angle between the pumping member (20) and the position member (10) is well adjusted.

Additionally, each of the ears (12) has a threaded hole (121) defined therein. Consequently, whoever, a left-handed person or a right-handed person, operates the present invention, he/she can easily screw the bolt (13).

As described above, the position seat for a hydraulic brake device of a bicycle in accordance with the present invention has several advantages as follows.

1. The angle between the position member (10) and the pumping member (20) is adjustable such that the position seat of the present invention is suitable to various handlebars of bicycles. As a result, the position seat of the present invention can be widely used.

2. The importance of the present invention is to divide the conventional position seat into two pieces. Consequently, the semi-finished workpiece is smaller than that of the conventional position seat and the gas holes are difficultly formed in the workpiece during molding.

Although the invention has been explained in relation to its preferred embodiment, it is to be understood that many other possible modifications and variations can be made without departing from the spirit and scope of the invention as hereinafter claimed.

What is claimed is:

1. A position seat for a hydraulic brake device of a bicycle, comprising a position member adapted to be mounted on a handlebar of a bicycle and a pumping member selectively pivotally mounted to the position member, wherein:
the position member includes a through hole and a slot respectively defined therein, the slot being parallel to an axis of the through hole, the slot including two opposite sides each formed with an ear having a threaded hole defined in each of the ear, a bolt sequentially extending through a corresponding one of the two threaded holes screwed into the other to shorten a width of the slot for securely forcing the pumping member, a hole defined in the position member and communicating with the through hole, a locking member mounted in the hole and extending into the through hole; and
the pumping member has a hollow structure, and includes a cylinder portion and containing portion disposed therein, the containing portion and the cylinder portion communicating with each other, a sheath longitudinally extending from the cylinder portion and received in the through hole, a semi-annular groove defined in an outer periphery of the sheath and communicating with the hole for partially receiving the locking member to prevent the pumping member from detaching from the position portion before screwing the bolt and limit a rotate range of the pumping member relative to the position member.

2. The position seat as claimed in claim 1, wherein the sheath includes an annular flange outward and radially extending from the cylinder portion to prevent the cylinder portion from overly extending into the through hole and ensure the semi-annular groove communicating with the hole when the sheath is received in the through hole.

3. The position seat as claimed in claim 1, wherein the bolt has a neck portion defined near an enlarged head thereof, the neck portion rotatably received in a corresponding one of the two threaded holes to prevent a locked condition from being occurred among the two ears and the bolt in place when screwing the bolt before holding the sheath.

4. The position seat as claimed in claim 1, wherein the locking member is a spring pin for east assembling.

5. The position seat as claimed in claim 2, wherein the bolt has a neck portion defined near an enlarged head thereof, the neck portion rotatably received in a corresponding one of the two threaded holes to prevent a locked condition from being occurred among the two ears and the bolt in place when screwing the bolt before holding the sheath.

6. The position seat as claimed in claim 2, wherein the locking member is a spring pin for east assembling.

7. The position seat as claimed in claim 3, wherein the locking member is a spring pin for east assembling.

8. The position seat as claimed in claim 5, wherein the locking member is a spring pin for east assembling.
